(19) United States
(12) Patent Application Publication
(10) Pub. No.: US 2026/0326331 A1
(43) Pub. Date: Oct. 22, 2026

(54) ULTRASONIC CHEF KNIFE

(71) Applicant: Guangdong GT Technology Co., LTD, Meizhou (CN)

(72) Inventors: QIANCAI LI, Longyan (CN); YONGGEN LAI, Meizhou (CN); SHUNMING QIU, Meizhou (CN)

(21) Appl. No.: 19/711,568

(22) Filed: Jun. 17, 2026

(30) Foreign Application Priority Data
Dec. 16, 2025 (CN) 202522666432.2

(51) Int. Cl. B26D 7/08

(52) U.S. Cl. CPC B26D 7/086; B26D 2210/02

(57) ABSTRACT

Disclosed is an ultrasonic chef knife, relating to the technical field of cutters, and including a housing handle and a welding portion. An interior of one end of the housing handle is provided with a transducer. A front cover and a blade of the ultrasonic chef knife are connected into an integrated structure by a welding technology. Through the integrated welding design, a path of acoustic energy loss caused by a connecting interface of parts in traditional assembly is eliminated, and transmission efficiency of ultrasonic energy is significantly improved.

### CROSS-REFERENCE TO RELATED APPLICATIONS

This application claims priority to Chinese Patent Application No. 202522666432.2, filed on Dec. 16, 2025, which is hereby incorporated by reference in its entirety.

### TECHNICAL FIELD

The present application relates to the technical field of cutters, in particular to an ultrasonic chef knife.

### BACKGROUND

Ultrasonic chef knife is an innovative kitchen knife that uses a high-frequency vibration technology to assist in cutting. A core feature of the ultrasonic chef knife is that a blade vibrates slightly at a very high frequency during cutting, thus reducing cutting resistance, preventing food from sticking and improving cutting efficiency.

In an existing product, a front cover of a transducer and a blade head are typically joined using separable designs such as threaded connection, clamping structure or fixing ring assembly. For example, some products are butted by pins, buckles or threads, and there is an inevitable assembly gap between components, which forms an obvious path of acoustic energy loss, leading to leakage and interruption of ultrasonic energy in a transmission process, which cannot achieve continuous and stable energy transmission and directly affects cutting efficiency.

### SUMMARY

The present application aims at providing an ultrasonic chef knife to solve the technical problems mentioned in the background above.

In order to achieve the above object, the present application provides a following technical solution: an ultrasonic chef knife includes a housing handle and a welding portion, wherein an interior of one end of the housing handle is provided with a transducer, an output end of the transducer is fixed with a front cover, the welding portion is arranged at one end of the front cover, the welding portion is inclined, one side of the welding portion is provided with a blade, and two sides of the front cover are provided with transition portions.

Further, an outer edge of one end of the front cover is stepped, and the front cover is embedded with the housing handle.

Further, the transition portion has a rounded corner profile.

Further, an interior of the housing handle is fixed with a main board, and one side of the main board is provided with a battery.

Further, a button is arranged at a top portion of the housing handle, and the button is electrically connected with the main board.

Further, connecting lugs are arranged at four corners of one end of the housing handle, and screws penetrate through interiors of the connecting lugs.

Further, connecting holes are arranged at four corners of one side of the front cover, and the connecting holes are in threaded connection with the screws.

The ultrasonic chef knife provided by the present application has the following beneficial effects.
1. The front cover and the blade of the present application are connected into an integrated structure by a welding technology, and through the integrated welding design, a path of acoustic energy loss caused by a connecting interface of parts in traditional assembly is eliminated, transmission efficiency of ultrasonic energy is significantly improved, and continuity and stability of energy transmission in the cutting process are ensured.
2. According to the present application, with the arrangement of the inclined welding portion, a bevel design of the ultrasonic chef knife greatly increases a welding contact area, which improves a mechanical strength of a welding node and makes a tool bit less prone to deformation or fracture when bearing a cutting force on one hand, and also optimizes a transmission interface of ultrasonic vibration and reduces an energy loss at this interface on the other hand.
3. According to the present application, due to the arrangement of the transition portion with a rounded corner profile, the rounded corner transition eliminates reflection and scattering loss of ultrasonic energy caused by structural abrupt change, so that ultrasonic vibration can be transmitted from the front cover to the blade more smoothly and efficiently, which enhances overall energy conversion and conduction performance, thereby improving cutting efficiency and effect.
4. According to the present application, the housing handle and the front cover adopt a tight and full-fit design, and the interior is fastened by four M4 screws, so that a surface of a joint is smooth and has no protruding structure, which takes appearance regularity and grip comfort of the product into account. With a balanced locking force brought by four M4 screws, high connection strength between the housing handle and the front cover is effectively ensured, and a risk of loosening caused by long-term ultrasonic vibration can be significantly reduced, so that reliability and stability of long-term operation of the ultrasonic chef knife are further ensured.

### BRIEF DESCRIPTION OF THE DRAWINGS

FIG. 1 is a schematic diagram showing an overall three-dimensional structure of an ultrasonic chef knife according to the present application;

FIG. 2 is a schematic diagram showing an internal structure of a housing handle of the ultrasonic chef knife according to the present application; and

FIG. 3 is a schematic diagram showing a three-dimensional structure of a front cover of the ultrasonic chef knife according to the present application.

In the drawings: 1—housing handle; 2—main board; 3—battery; 4—button; 5—transducer; 6—front cover; 7—welding portion; 8—blade; 9—transition portion; 10—connecting lug; 11—screw; and 12—connecting hole.

### DESCRIPTION OF EMBODIMENTS

The specific implementations of the present application will be further described below with reference to the drawings and embodiments. The following embodiments are merely illustrative of the present application, but are not intended to limit the scope of the present application.

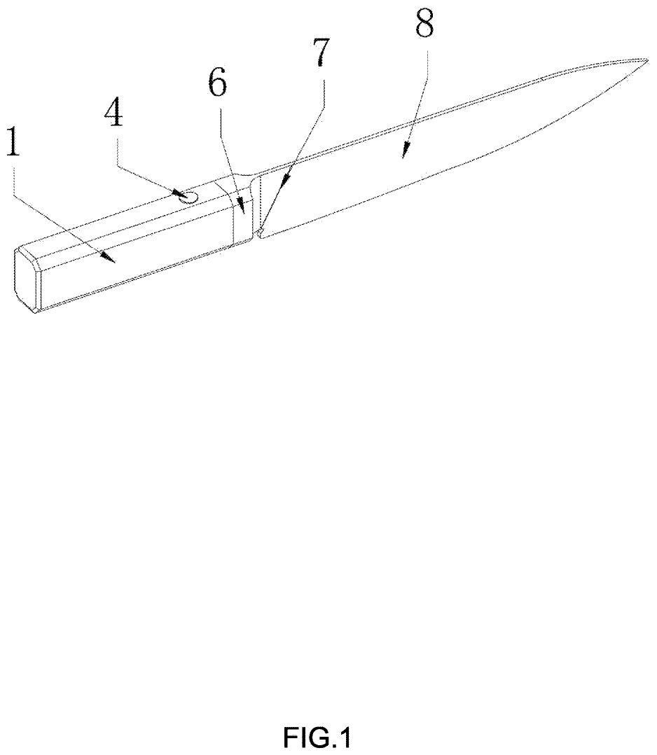

As shown in FIG. 1 to FIG. 3, an ultrasonic chef knife includes a housing handle 1 and a welding portion 7. An interior of the housing handle 1 is fixed with a main board 2, and one side of the main board 2 is provided with a battery 3. The battery 3 may supply power to the main board 2. A button 4 is arranged at a top portion of the housing handle 1, the button 4 is electrically connected with the main board 2, and start and stop of the ultrasonic chef knife are controlled by the button 4. An interior of one end of the housing handle 1 is provided with a transducer 5, and an output end of the transducer 5 is fixed with a front cover 6. The transducer 5 may drive the front cover 6 to vibrate. A welding portion 7 is arranged at one end of the front cover 6, and the welding portion 7 is inclined. The front cover and a blade are connected into an integrated structure by a welding technology, eliminating a path of acoustic energy loss caused by a connecting interface of parts in traditional assembly, and meanwhile, a bevel design of the ultrasonic chef knife greatly increases a welding contact area, which improves a mechanical strength of a welding node and makes a tool bit less prone to deformation or fracture when bearing a cutting force on one hand, and also optimizes a transmission interface of ultrasonic vibration and reduces an energy loss at this interface on the other hand. An outer edge of one end of the front cover 6 is stepped, and the front cover 6 is embedded with the housing handle 1, improving convenience during mating. One side of the welding portion 7 is provided with a blade 8, and two sides of the front cover 6 are provided with transition portions 9. The transition portion 9 has a rounded corner profile and the rounded corner transition eliminates reflection and scattering loss of ultrasonic energy caused by structural abrupt change, so that ultrasonic vibration can be transmitted from the front cover 6 to the blade 8 more smoothly and efficiently.

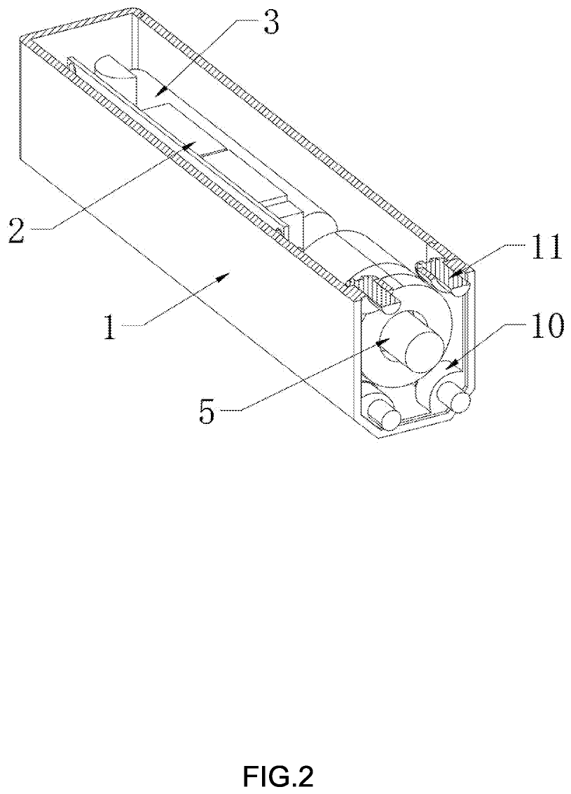

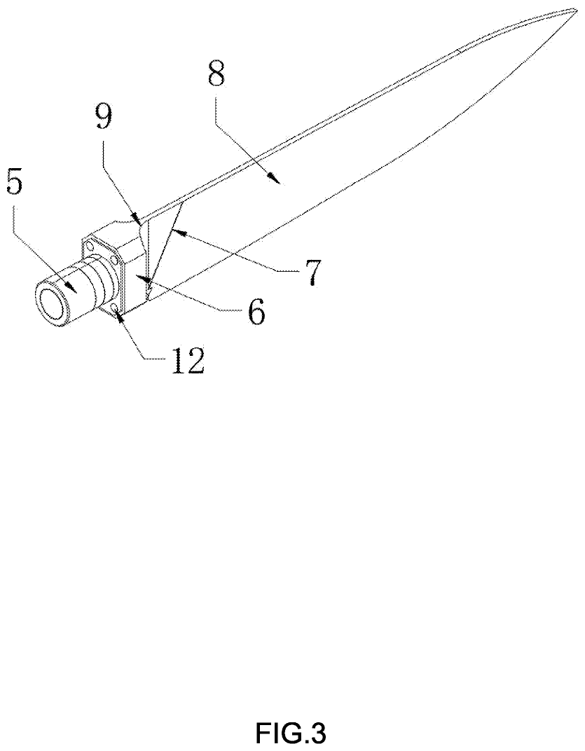

As shown in FIG. 2 and FIG. 3, connecting lugs 10 are arranged at four corners of one end of the housing handle 1, and screws 11 penetrate through interiors of the connecting lugs 10. The screws 11 are arranged inside the housing handle 1, so that a surface of a joint is smooth and has no protruding structure, which takes appearance regularity and grip comfort of the product into account. Connecting holes 12 are arranged at four corners of one side of the front cover 6, and the connecting holes 12 are in threaded connection with the screws 11. With a balanced locking force brought by four M4 screws 11, high connection strength between the housing handle 1 and the front cover 6 is effectively ensured, and a risk of loosening caused by long-term ultrasonic vibration can be significantly reduced.

To sum up, when the ultrasonic chef knife is in use, firstly, according to the structure shown in FIG. 1, FIG. 2 and FIG. 3, during production, the front cover 6 and the blade 8 are connected into an integrated structure by a welding technology. Through the integrated welding design, the path of acoustic energy loss by the connecting interface of the parts in the traditional assembly is eliminated. At the same time, through the inclined welding portion 7, the bevel design greatly increases the welding contact area, improves the mechanical strength of the welding node, and makes the blade less prone to deformation or fracture when bearing the cutting force. Then, in the process of use, the housing handle 1 and the front cover 6 are tightly fitted, and the interior is fastened with four M4 screws 11, so that the surface of the joint is smooth and has no protruding structure, which takes the appearance regularity and the grip comfort of the product into account. Next, through the button 4, the battery 3 supplies power to the main board 2, and the transducer 5 is controlled to work. In this case, the rounded corner transition portion 9 eliminates the reflection and scattering loss of the ultrasonic energy caused by the structural abrupt change, so that the ultrasonic vibration can be transmitted from the front cover 6 to the blade 8 more smoothly and efficiently, thereby assisting in the cutting of food ingredients. Finally, during the use process, with the balanced locking force brought by the four M4 screws 11, the high connection strength between the housing handle 1 and the front cover 6 is effectively ensured, and the risk of loosening caused by long-term ultrasonic vibration can be significantly reduced, so that reliability and stability of long-term operation of the ultrasonic chef knife are further ensured.

The embodiments of the present application are given for the purpose of illustration and description, and are not intended to be exhaustive or to limit the present application to the form disclosed. Many modifications and variations are obvious to those of ordinary skills in the art. The embodiments are chosen and described in order to better explain the principles and practical applications of the present application, and to enable those of ordinary skills in the art to understand the present application, thus designing various embodiments with various modifications suitable for specific uses.

What is claimed is:

1. An ultrasonic chef knife, comprising a housing handle and a welding portion, wherein an interior of one end of the housing handle is provided with a transducer, an output end of the transducer is fixed with a front cover, the welding portion is arranged at one end of the front cover, the welding portion is inclined, one side of the welding portion is provided with a blade, and two sides of the front cover are provided with transition portions.

2. The ultrasonic chef knife according to claim 1, wherein an outer edge of one end of the front cover is stepped, and the front cover is embedded with the housing handle.

3. The ultrasonic chef knife according to claim 1, wherein the transition portion has a rounded corner profile.

4. The ultrasonic chef knife according to claim 1, wherein an interior of the housing handle is fixed with a main board, and one side of the main board is provided with a battery.

5. The ultrasonic chef knife according to claim 4, wherein a button is arranged at a top portion of the housing handle, and the button is electrically connected with the main board.

6. The ultrasonic chef knife according to claim 1, wherein connecting lugs are arranged at four corners of one end of the housing handle, and screws penetrate through interiors of the connecting lugs.

7. The ultrasonic chef knife according to claim 6, wherein connecting holes are arranged at four corners of one side of the front cover, and the connecting holes are in threaded connection with the screws.
